(19) United States
(12) Patent Application Publication
(10) Pub. No.: US 2011/0067044 A1
(43) Pub. Date: Mar. 17, 2011

(54) INTERACTIVE PLATFORM FOR BROADCAST PROGRAMS

(76) Inventor: Robert W. Albo, Orinda, CA (US)

(21) Appl. No.: 12/878,834

(22) Filed: Sep. 9, 2010

Related U.S. Application Data
(60) Provisional application No. 61/242,104, filed on Sep. 14, 2009.

(51) Int. Cl. H04N 7/16

(52) U.S. Cl. 725/13

(57) ABSTRACT

A survey message is received at a server from a host of a broadcast station currently broadcasting a program over a broadcast network, which is one of a TV program and radio program, where the survey message is to survey an audience of the program concerning content of the program. The survey message is then transmitted to communication devices of a plurality of users who have registered with the server to participate in the program over a data network. Response messages are received from at least some of the registered users in response to the survey message, each response message including geographic information collected from the communication devices of the users. An analysis is performed on the response messages to generate a statistical result representing percentages of answers selected by the users in view of the geographic and/or demographic information of the users. The statistical result is then transmitted to the broadcast station to allow the host to instantly incorporate the statistical result into the broadcast program being broadcast in the broadcast network.

### RELATED APPLICATIONS

This application claims the benefit of co-pending U.S. Provisional Patent Application No. 61/242,104, entitled “Game Show and Interactive Platform for Television Broadcast”, filed Sep. 14, 2009, which is incorporated by reference herein in its entirety.

### FIELD OF THE INVENTION

Embodiments of the invention relate generally to the field of interactive broadcast systems; and more particularly, to an interactive broadcast system with real-time statistical analysis of responses from users.

### BACKGROUND

Interactive TV (ITV) refers to enhancing TV programs with interactive services for the end-user. These services include, for example, retrieving electronic information from, or sending electronic information to, specific Web sites via a dedicated set-top box (STB) within a context of the live-broadcast program. Examples of ITV are games for a TV audience, or interacting with an advertisement being broadcast. These systems allow advertisers and others to create interactive enhancements to traditional TV programs. Viewers can purchase products or order brochures with a click of their remote control communicating with a STB or TV set that has a client software built-in, during an enhanced program. Other programs provide software for STBs that enables digital interactive television for enhanced applications such as e-commerce. However, such conventional ITV programs in general lack real time statistical analysis on the user's responses and the responses from the users are not incorporated into the ongoing broadcast program instantly.

Interactive connection is one or one in real time. TV and radio broadcast may incorporate real time input from the home audience but it's always a single user who is lucky enough to get through and be selected. For example, a radio talk show or game contest takes input from a single user but never from a group of users because it's too difficult to synthesize and consolidate the inputs of the group in real time.

### SUMMARY OF THE DESCRIPTION

A survey message is received at a server from a host of a broadcast station currently broadcasting a program over a broadcast network, which is one of a TV program and radio program, where the survey message is to survey an audience of the program concerning content of the program. The survey message is then transmitted to communication devices of a plurality of users who have registered with the server to participate in the program over a data network. Response messages are received from at least some of the registered users in response to the survey message, each response message including geographic information collected from the communication devices of the users. An analysis is performed on the response messages to generate a statistical result representing percentages of answers selected by the users in view of the geographic and/or demographic information of the users. The statistical result is then transmitted to the broadcast station to allow the host to instantly incorporate the statistical result into the broadcast program being broadcast in the broadcast network.

Other features of the present invention will be apparent from the accompanying drawings and from the detailed description which follows.

### BRIEF DESCRIPTION OF THE DRAWINGS

Embodiments of the invention are illustrated by way of example and not limitation in the figures of the accompanying drawings in which like references indicate similar elements.

FIG. 1 is a block diagram illustrating a system an interactive broadcast program according to one embodiment of the invention.

FIG. 2 is a flow diagram illustrating a method for managing interactive broadcast programs according to one embodiment.

FIG. 3 is a flow diagram illustrating a method for registering users in interactive broadcast programs according to one embodiment.

FIG. 4 is a block diagram of a data processing system, which may be used with one embodiment of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

According to some embodiments, an interactive platform for broadcast program, such as TV game shows or radio talk shows, allows all members of the audience (e.g., home audience) to participate in the broadcast program by watching and/or listening to the broadcast program, which may be broadcast over a broadcast network (e.g., traditional radio frequency or RF broadcast over air way, cable TV, or satellite TV/radio, etc.), and interacting in real time such as answering questions using a communication device such as a mobile phone or portable computer (e.g., via emails or social networking environments such as Facebook™ or Twitter™ over the Internet). This changes the role of a user from passive to an active participant. It can also leverage the group wisdom of the audience.

In one embodiment, participants may be able to win awards (e.g., cash, opportunity to be a future program show participant, etc.) This may work for new shows and reruns, as well as other events (e.g., sports events). This synchronization of interactive online with program broadcast can create a new genre of program shows. In addition, once the participant information is built into a customer relationship database, such information can be used to market virally to this group which represents an inexpensive and effective way to increase the audience size.

Although there are many systems dealing with broadcast TV and interactive services, all of these systems utilize the interactive services as a distribution vehicle for the broadcast TV programs. Embodiments of the present invention are much different. An embodiment of the invention utilizes the program broadcast as the distribution vehicle but integrates the interactive services from the audience as an important part of the program. Throughout this application, a TV program is utilized as an example of broadcast program. However, it is not so limited; other broadcast programs such as radio broadcast programs can also be applied.

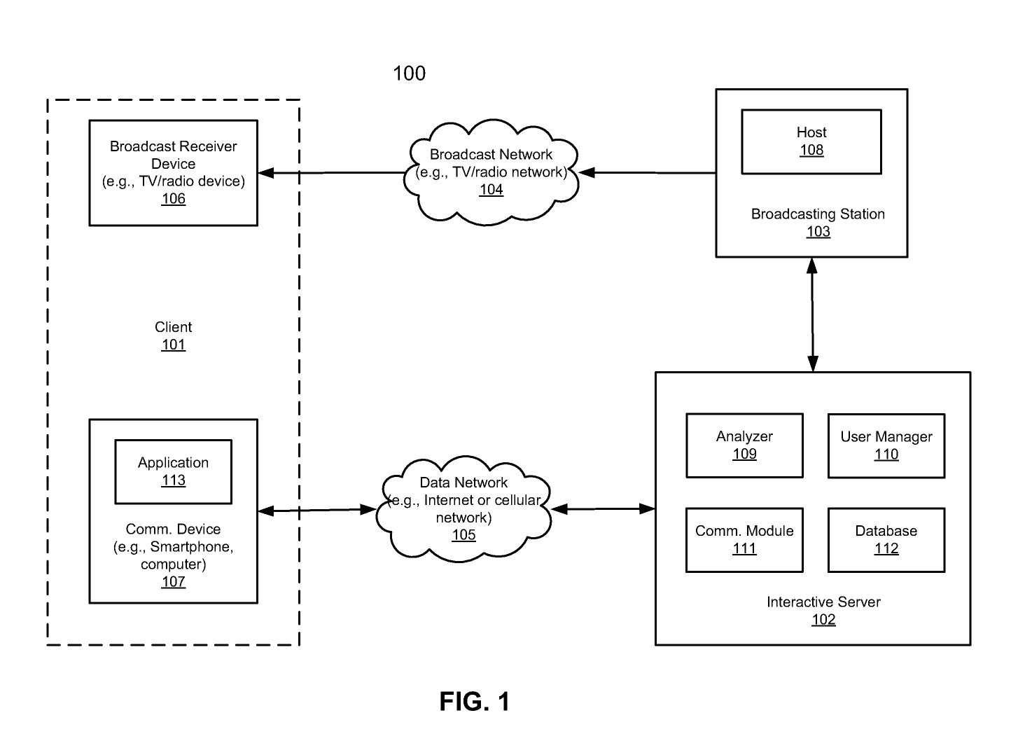

FIG. 1 is a block diagram illustrating a system an interactive broadcast program according to one embodiment of the invention. Referring to FIG. 1, system 100 includes, but not limited to, client 101 communicative coupled to interactive server 102 and broadcast station 103 over networks 104 and 105. Broadcast station 103 may be a radio station and/or a TV station. Radio broadcasting is an audio (sound) broadcasting service, broadcast through the air as radio waves (a form of electromagnetic radiation) from a transmitter to a receiving antenna. Stations can be linked in radio networks to broadcast common programming, either in syndication or simulcast or both. Audio broadcasting also can be done via cable FM, local wire networks, satellite and the Internet. A television station is a type of broadcast station that broadcasts video and usually audio to television receivers in a particular area.

Network 104 may be a traditional broadcast network over the air, a cable network, a satellite network, or a combination thereof. Network 105 may be any kind of data or packetized networks such as local area network (LAN), wide area network (WAN), or a combination thereof, wired or wireless. For example network 105 may be part of the Internet. Alternatively, network 105 may be part of a cellular network. Networks 104-105 may be the same network (e.g., single or a combination of multiple networks) with different communications links or media.

Client 101 may represent any kind of users such as TV viewers or radio listeners in a variety of environments such as their own homes or other social event places (e.g., coffee shops). Client 101 includes broadcast receiver device 106 to receiver content or signals broadcast from broadcast station 103 over broadcast network 104 and a communication device 107 to communicate with interactive server 102 over data network 105. Broadcast receiver device 106 may be any media (e.g., TV/radio) receiver device with a proper media output interface (e.g., display and/or speaker), which may include a signal converter (e.g., cable or set-top box, modem, or satellite receiver). Communication device 107 may be any kind of electronic or computing devices, such as portable or handheld computers, personal digital assistants (PDAs), media players, gaming devices, mobile phones, desktops/workstations, or a combination thereof. Although a single client is shown, it will be appreciated that multiple clients will be implemented in system 100. Also, it will be appreciated that no special equipment is required at the client since most people have access to a radio or television and a cell phone or computer connected to the internet. Also, no special training is required at the client to use the system (very intuitive).

Interactive server 102 may be implemented as a Web server and/or an application server. In one embodiment, server 102 includes, but not limited to, response analyzer 109, user manager 110, communications module 111, and database 112. User manager 110 is responsible for managing users that have registered with the system to participate in the interactive broadcast programs. In one embodiment, interactive server 102 provides a user interface such s Web interface to allow users such as client 101 to log in and register as a member of the system. During the registration (a one time event), a user may also specify the demographic or location information of the user and its preference of certain types of broadcast programs. Demographic information may include: name, address, age, sex, email address, cell phone number, political party and preferences. A list of broadcast programs may be presented to client 101 to select one or more of the programs for participation. In addition, a user may also specify certain preferences, such as preferred communications methods and/or devices for communications purposes. Such user information, program information, and selection of the programs may be stored in database 112, which may be implemented as a single database or multiple databases and located locally or remotely. The database is effectively a customer relationship management system (CRM) since all user demographics and interactions are stored here.

According to one embodiment, when a broadcast program is broadcast from broadcast station 103 over broadcast network 104, host 108 of the program may transmit a survey or question to interactive server 102. For each of the users that have registered in participation of the program, communication module 111 is configured to forward with optional editing the survey message to the user over network 105, in this example, client 101. The survey message may be transmitted through a variety of communications mechanisms, such as emails, short message system (SMS) messages, social networks (e.g., Facebook™ or Twitter™), dependent upon the user's preference which may be specified in the corresponding user profile during the registration and stored in database 112.

The survey message may be received by application 113 of client 101, where application 113 may be downloaded and installed during the registration. Application 113 is specifically configured to handle the interactive broadcast program communications. For example, application 113 may provide a graphical user interface to a user of communication device 107 to allow the user to respond to the survey message. Application 113 may also control certain requirements or restrictions of the participation, for example, to prevent any cheating attempts. When a user responds, a response message is transmitted by application 113 to interactive server 102 and received by communication module 111.

In response to the response message forwarded from communication module 111, response analysis module 109 is configured to perform an analysis on the response message in view of other response messages received from other users to generate a statistical report. The statistical report may include information concerning how a particular user has been performing for a past predetermined period of time, which may also be stored in database 112. The statistical report may include statistics concerning all of the users who have responded, such as, percentages among certain choices of responses. The statistical report may be categorized in terms of demographics of the users. It may also use text search of the user messages to gain insights into what people are saying or thinking. Alternatively, it may include current locations of the users which may be obtained by application 113 by invoking a global positioning system (GPS) unit of device 107, etc.

In one embodiment, the statistical report may be transmitted to broadcast station 103 to allow host 108 to instantly incorporate the report into the ongoing broadcast program, such that the audience can immediately know the same data over broadcast network 104. This can be done through a data interface to the broadcaster whereby the data can be displayed in the program or streamed in a banner at the bottom of the screen (like stock quotes in a financial program). Alternatively, the summary data can be given to the broadcast host for him or her to broadcast the information. In addition, the statistical report may also be transmitted to the communication devices (e.g., device 107) of the registered users via network 105. As a result, the audience of the program can see how other users' response, even though some of the people in the audience may not participate in the interactive portion. Such statistics may also be stored in database 112 for future and other usages such as targeted advertisements, etc.

Further, database 112 may also capture shows watched, performance and awards won by the users. It could also be used to do online surveys or promotions for the program or advertisers (e.g. advertising effectives). Finally, it can be used to viral market to followers and track effectiveness. The platform application may integrate and process data from “online” and “on air”. Each platform application would be specific to each program. It may send messages to users (e.g. reminder of game show, individual questions, etc.), receive messages from the users (answers), process messages (who got answer right/wrong, did message arrive before game show host broadcast answer, etc) and send messages to program show or broadcaster host (average answer from audience, who got all answers right, etc.) Note that interactive server 102 and broadcast station 103 may be operated and/or owned by the same entity or different entities or organizations.

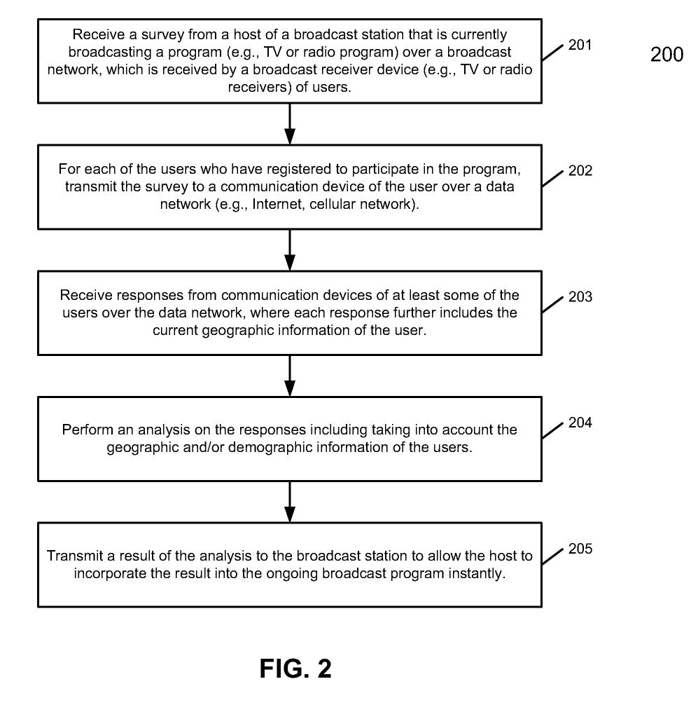

FIG. 2 is a flow diagram illustrating a method for managing interactive broadcast programs according to one embodiment. For example, method 200 may be performed by server 102 of FIG. 1. Referring to FIG. 2, at block 201, a survey is received from a host of a broadcast station that is currently broadcasting a program (e.g., TV or radio show) over a broadcast network, which is being received at a broadcast receiver device (e.g., TV or radio receivers) of the users. At block 202, for each of the users who have registered with the system to participate in an interactive portion of the program, the survey message is transmitted to a communication device of the user over a data network (e.g., Internet or cellular network). In response, response messages are received from the communication devices of at least some of the users over the data network, where each response message may include the current geographic information of the user (e.g., GPS information). At block 204, an analysis is performed on the response messages of the users including taking into account of the geographic and/or demographic information. At block 205, a result of the analysis is transmitted to the broadcast station to allow the host to instantly incorporate the result into the ongoing broadcast program.

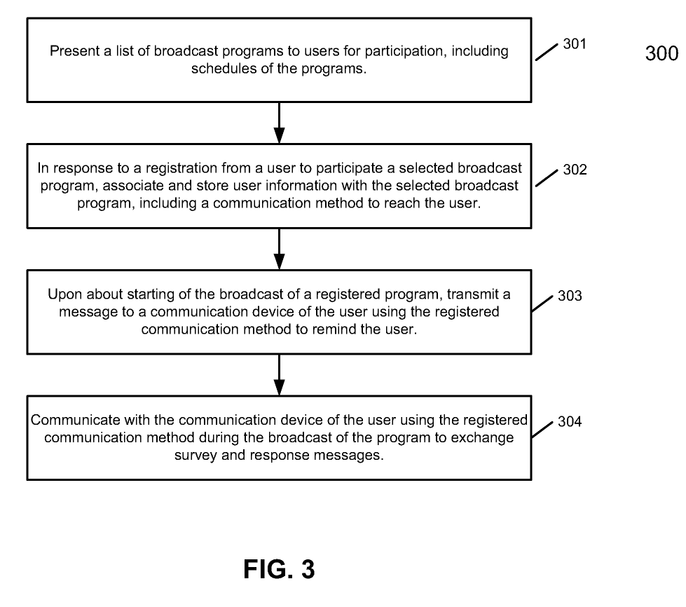

FIG. 3 is a flow diagram illustrating a method for registering users in interactive broadcast programs according to one embodiment. Method 300 may be performed by interactive server 102 of FIG. 1. Referring to FIG. 3, at block 301, a list of broadcast programs is presented to users for participation, including the schedules of the programs. In response to a registration from a user to participate a selected broadcast program, at block 302, the user information is associated with the selected broadcast program and stored in a database, including a communication method to reach the user. Upon about starting the selected broadcast program, at block 303, a reminder may be transmitted to each of the users who have registered via the preferred communication method of the user. At block 304, messages (e.g., survey and/or responses) are exchanged with the users using their preferred communication methods during the broadcast program.

According to one embodiment, the above techniques can be applied to a variety of programs. For example, they can be applied to real-time TV game show. In this situation, home audience may register on the system described above. Home audience may get a reminder of game show start. Home audience may get a direct online message with the first question (SMS, Twitter, voice message, etc). All questions and answers are coordinated with broadcast. It is assumed that the program may be simultaneously broadcast across all time zones but if not, the system may coordinate based on location of participant (e.g. west coast plays 3 hours after east coast). Home audience may respond with answer (reply on SMS, Twitter, interactive voice response (IVR), etc.). Each home participant answer is scored or graded and the answer is sent. Everyone's performance is tracked, such as best performers, average answers etc. Game show may likely incorporate interactive real time responses into program. For example, the average audience answer is the answer to beat for game show participants. This process may be repeatedly performed for each question in a game show. A summary message may be provided to users with their performance, average audience performance and awards won. The summary data may also be provided to game show (highlight best performers, credit award to winners, etc.) It also allows advertiser or TV station to survey online viewers or get feedback from users. They can put in campaigns to promote game show program or advertiser over social media (viral marketing among show followers). They can also use online marketing in social media to promote the TV program and to register users.

According to another embodiment, the above techniques may also be applied to pre-recorded TV game shows. In this situation, home audience may register on the system. Home audience may get a reminder of game show start and the home audience may get a direct online message with the first question (SMS, Twitter, voice message, etc). The system may have all questions and answers and coordinate with broadcast. The system may assume that the program may be simultaneously broadcast across all time zones but if not, the system may coordinate based on location of participant (e.g. west coast plays 3 hours after east coast). Home audience may respond with answer (reply on SMS, Twitter, interactive voice response (IVR), etc.) The system may score each home participant answer and send answer which could include some trivia. The system may track everyone's performance, best performers, average answers etc. Although game show is pre-recorded, there may be a live host who could incorporate interactive real time responses into program. For example, GSN Live has a real time host and s/he could incorporate audience answers (e.g. Charlie in S.F. guessed the exact number of marbles). One point, some people in the audience may know the answer because they have already seen the show but that is fine since we really just want participation. Also, the host may be real time in just one time zone so this may be the only area where answers can be incorporated into the program. The system may repeat the process for each question in game show. The system may provide a summary message to users with their performance, average audience performance and awards won. The system may also provide summary data to live host (highlight best performers, credit award to winners, etc.) The system may allow advertiser or TV station to survey online viewers or get feedback from users. They may put in campaigns to promote game show program or advertiser over social media (viral marketing among show followers). They may also use online marketing in social media to promote the TV program and to register users.

According to a further embodiment, the techniques described above may also be applied to non-TV game shows such as social events. In this situation, home audience may register with the system for an event. Home audience may get a reminder of the event start. Home audience may get a direct online message with the first question such as what may be the next play in the Super Bowl game. Home audience may respond with answer (reply on SMS, Twitter, interactive voice response (IVR), etc.) The system may score each home participant answer and send the answer which could include some trivia. The system may track everyone's performance, best performers, average answers etc. The process could continue and an award could be given to the home audience participant who best forecasted the plays of the game.

Furthermore, the techniques described above may also be applied to a particular type of game shows such as “Wisdom of People Game Show.” Imagine a television game show where the home audience, using a mobile phone or computer and can compete real time against the game show participants. This would change the audience experience from passive to active participation and create a hybrid broadcast interactive format. This new paradigm would generate a lot of buzz and publicity which would drive large television audiences. The game show would involve 3 or 4 game show participants who are asked a series of questions which require a numeric answer. Each question would be worth an escalating amount of money or credits. Sample questions might include:

how many marbles are in a glass jar (everyone would see it)

what did this house in Wyoming recently sell (virtual tour)

what is the cost in dollars for this meal in a small village in India

After the game show host poses the question, the home audience would send its independent answers/guesses using a mobile phone (SMS) or computer to Twitter or another social media/communication platform. All of the home audience answers would be recorded and the median value would represent the home audience answer. The game show host would get each game show participant's written answer, announce the actual answer and then announce the home audience answer. The game show host would then identify which participants got the question right by getting closer to the actual answer than the audience group answer. The game show host might ask about their logic or approach and explain the logic of an expert. There could be bonus dollars or credits if the participant gets the exact answer.

The game show software application would track how well each home audience participant is doing. After each question, home participants could receive a text message giving the actual answer, getting some trivia about the question, etc. The home audience participant who performs the best during the show or who gets a tough question exactly right could win a prize such as an invitation to be a future game show participant or other incentives. Additionally, the game show host could make comments on how the home audience is doing or how the best home participants are doing.

The interactive platform is available today. The internet or the cellular network (SMS) or land line telephone (IVR) provide the game show audience interactive communication network; embodiments of the invention would provide the interactive concept, game show script, game show application and support. To play from home and potentially win prizes, each home audience participant may need to register and provide information such as demographics, address, email, etc. As such, the application may act as a CRM system which can be used in other ways such as online promotions or getting real-time feedback from consumers (surveys). It can also notify followers when the TV show is about to begin. It would be expected millions of people to register and this user database may be very valuable.

This game show has a number of unique features. First and foremost, it applies the real time a real time interactive platform to broadcast television. This would generate a lot of buzz in the entertainment and technology sector and drive a larger viewing audience. Second, the show takes advantage of the phenomenon that a group of independent people may normally reach a more accurate group answer than any one individual, even an expert. People may love seeing this in action. Third, the show may put the home audience in many foreign situations such as guessing the price of a wonderful meal in a developing country or the number of trout in a pond or the price of an apartment in a developed country. Fourth, everyone gets to play and has a chance to win. It's not limited to the few who are lucky enough to be selected.

In another embodiment, a politician could have a weekly talk show. The politician could test messages and then get aggregated input from the listening audience. This would allow the politician to know what's important to voters based on demographic information (e.g. undecided, 18-25 year old female).

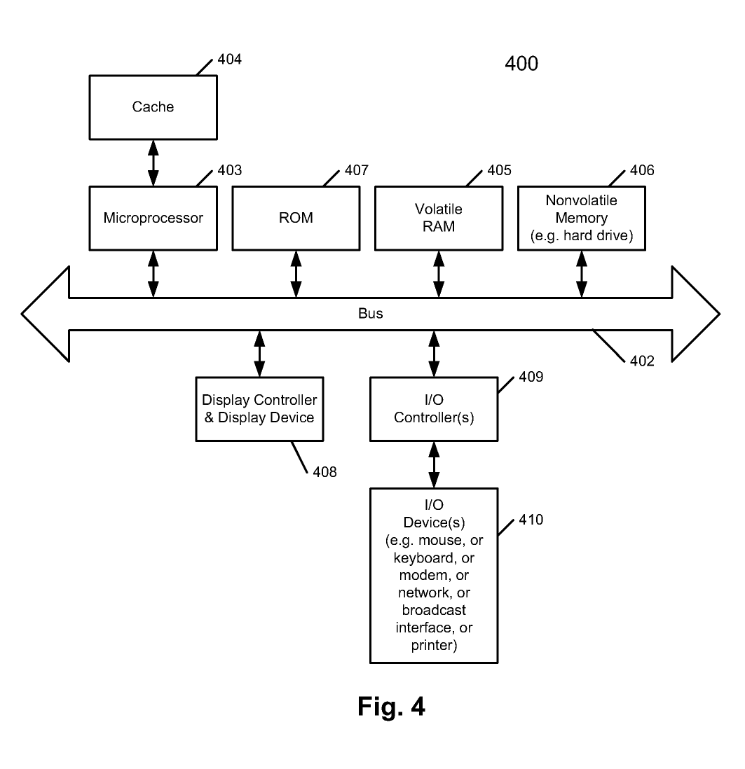

FIG. 4 is a block diagram of a data processing system, which may be used with one embodiment of the invention. For example, the system 400 shown in FIG. 4 may be used as device 107, server 102, or broadcast station 103 of FIG. 1. Note that while FIG. 4 illustrates various components of a computer system, it is not intended to represent any particular architecture or manner of interconnecting the components; as such details are not germane to the present invention. It may also be appreciated that network computers, handheld computers, cell phones and other data processing systems which have fewer components or perhaps more components may also be used with the present invention. The computer system of FIG. 4 may, for example, be an Apple Macintosh computer or MacBook, or an IBM compatible PC.

As shown in FIG. 4, the computer system 400, which is a form of a data processing system, includes a bus or interconnect 402 which is coupled to one or more microprocessors 403 and a ROM 407, a volatile RAM 405, and a non-volatile memory 406. The microprocessor 403 is coupled to cache memory 404. System performance will be an important factor because many messages will be received and sent in a short window of time. Cache memory is used to provide this high performance. The bus 402 interconnects these various components together and also interconnects these components 403, 407, 405, and 406 to a display controller and display device 408, as well as to input/output (I/O) devices 410, which may be mice, keyboards, modems, network interfaces, printers, and other devices which are well-known in the art.

Typically, the input/output devices 410 are coupled to the system through input/output controllers 409. The output could be an interface to the television broadcast which would allow streaming of consolidated data on a banner of the bottom of the television screen (similar to stock quotes streaming at bottom of a financial broadcast. Alternatively, the output could be a summary of user input (e.g. average answer) or projections based on data & user demographics (25 year old women care about equal rights) which is displayed on a screen for the host of the broadcast. The volatile RAM 405 is typically implemented as dynamic RAM (DRAM) which requires power continuously in order to refresh or maintain the data in the memory. The non-volatile memory 406 is typically a magnetic hard drive, a magnetic optical drive, an optical drive, or a DVD RAM or other type of memory system which maintains data even after power is removed from the system. Typically, the non-volatile memory may also be a random access memory, although this is not required.

While FIG. 4 shows that the non-volatile memory is a local device coupled directly to the rest of the components in the data processing system, the present invention may utilize a non-volatile memory which is remote from the system; such as, a network storage device which is coupled to the data processing system through a network interface such as a modem or Ethernet interface. The bus 402 may include one or more buses connected to each other through various bridges, controllers, and/or adapters, as is well-known in the art. In one embodiment, the I/O controller 409 includes a USB (Universal Serial Bus) adapter for controlling USB peripherals. Alternatively, I/O controller 409 may include an IEEE-1394 adapter, also known as FireWire adapter, for controlling FireWire devices.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the invention also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially. Embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method for interactive broadcast programs, the method comprising:
receiving, at a server, a survey message from a host of a broadcast station currently broadcasting a program over a broadcast network, which is one of a TV program and radio program, the survey message to survey an audience of the program concerning content of the program;
transmitting the survey message to communication devices of a plurality of users who have registered with the server to participate in the program over a data network;
receiving a plurality of response messages from at least some of the registered users in response to the survey message, each response message including geographic and/or demographic information collected from the communication devices of the users;
performing an analysis on the response messages to generate a statistical result representing percentages of a plurality of answers selected by the users in view of the geographic information of the users, user demographics and/or text analysis of messages for insights;
transmitting the statistical result to the broadcast station to allow the host to instantly incorporate the statistical result into the broadcast program being broadcast in the broadcast network; and
optimizing overall performance through techniques using cache memory and transmitting messages in groups.

2. The method of claim 1, further comprising:
prior to broadcasting the program, presenting a list of a plurality of programs to be broadcast by the broadcast station to the users for registration purposes; and
in response to a selection of one or more programs from the users, associating and storing user information with the selected one or more programs in a database, wherein the survey message is sent only to those who have selected the program for participation.

3. The method of claim 2, wherein the user information further includes a communication method to reach the communication device of the user, wherein the survey message is sent to the communication device of the user according to the selected communication method.

4. The method of claim 2, further comprising downloading an application to the communication device of the user during the registration to be installed in the communication device, where the application is configured to communicate with a global positioning system (GPS) unit of the communication device to collect the geographic information of the communication device.

5. The method of claim 1, wherein at least a portion of the statistical result is broadcast instantly by the broadcast station while the program is still progressing.

6. The method of claim 1, wherein the statistical result includes information indicating correctness of responses of each user in a past predetermined period of time and optionally overlays user demographics or use full text search of user messages to gain insights of what the group is saying or thinking.

7. A computer-readable storage medium having computer instructions stored therein, which when executed by a computer, cause a computer to perform a method for interactive broadcast programs, the method comprising:
receiving, at a server, a survey message from a host of a broadcast station currently broadcasting a program over a broadcast network, which is one of a TV program and radio program, the survey message to survey an audience of the program concerning content of the program;
transmitting the survey message to communication devices of a plurality of users who have registered with the server to participate in the program over a data network;
receiving a plurality of response messages from at least some of the registered users in response to the survey message, each response message including geographic and/or demographic information collected from the communication devices of the users;
performing an analysis on the response messages to generate a statistical result representing percentages of a plurality of answers selected by the users in view of the geographic information of the users;
transmitting the statistical result to the broadcast station to allow the host to instantly incorporate the statistical result into the broadcast program being broadcast in the broadcast network; and
optimizing overall performance through techniques using cache memory and transmitting messages in groups.

8. The computer-readable storage medium of claim 7, wherein the method further comprises:
prior to broadcasting the program, presenting a list of a plurality of programs to be broadcast by the broadcast station to the users for registration purposes; and
in response to a selection of one or more programs from the users, associating and storing user information with the selected one or more programs in a database, wherein the survey message is sent only to those who have selected the program for participation.

9. The computer-readable storage medium of claim 8, wherein the user information further includes a communication method to reach the communication device of the user, wherein the survey message is sent to the communication device of the user according to the selected communication method.

10. The computer-readable storage medium of claim 8, wherein the method further comprises downloading an application to the communication device of the user during the registration to be installed in the communication device, where the application is configured to communicate with a global positioning system (GPS) unit of the communication device to collect the geographic information of the communication device.

11. The computer-readable storage medium of claim 7, wherein the at least a portion of the statistical result is broadcast instantly by the broadcast station while the program is still progressing.

12. The computer-readable storage medium of claim 7, wherein the statistical result includes information indicating correctness of responses of each user in a past predetermined period of time and optionally overlays user demographics or use full text search of user messages to gain insights of what the group is saying or thinking.

13. A data processing system, comprising:
a communication module to receive a survey message from a host of a broadcast station currently broadcasting a program over a broadcast network, which is one of a TV program and radio program, the survey message to survey an audience of the program concerning content of the program, wherein the communication module is configured to transmit the survey message to communication devices of a plurality of users who have registered with the server to participate in the program over a data network, and wherein the communication module is configured to receive a plurality of response messages from at least some of the registered users in response to the survey message, each response message including geographic and/or demographic information collected from the communication devices of the users; and
a response analyzer to perform an analysis on the response messages to generate a statistical result representing percentages of a plurality of answers selected by the users in view of the geographic information of the users, including optimizing overall performance through techniques using cache memory and transmitting messages in groups, wherein the communication module is configured to transmit the statistical result to the broadcast station to allow the host to instantly incorporate the statistical result into the broadcast program being broadcast in the broadcast network.

14. The system of claim 13, further comprising a user manager and a database, wherein prior to broadcasting the program, the user manager is configured to present a list of a plurality of programs from the database to be broadcast by the broadcast station to the users for registration purposes, and wherein in response to a selection of one or more programs from the users, the user manager is configured to associate and store user information with the selected one or more programs in the database, wherein the survey message is sent only to those who have selected the program for participation.

15. The system of claim 14, wherein the user information further includes a communication method to reach the communication device of the user, wherein the survey message is sent to the communication device of the user according to the selected communication method.

16. The system of claim 14, wherein an application is downloaded to the communication device of the user during the registration to be installed in the communication device, where the application is configured to communicate with a global positioning system (GPS) unit of the communication device to collect the geographic information of the communication device.

17. The system of claim 13, wherein at least a portion of the statistical result is broadcast instantly by the broadcast station while the program is still progressing.

18. The system of claim 13, wherein the statistical result includes information indicating correctness of responses of each user in a past predetermined period of time and optionally overlays user demographics or use full text search of user messages to gain insights of what the group is saying or thinking.
